(19) United States
(12) Patent Application Publication
(10) Pub. No.: US 2025/0073905 A1
(43) Pub. Date: Mar. 6, 2025

(54) ROBOT WELDING SYSTEM

(71) Applicant: NACHI-FUJIKOSHI CORP., Tokyo (JP)

(72) Inventors: Ryota WATANABE, Toyama-shi (JP); Taiga YAMAUCHI, Toyama-shi (JP)

(73) Assignee: NACHI-FUJIKOSHI CORP., Tokyo (JP)

(21) Appl. No.: 18/825,093

(22) Filed: Sep. 5, 2024

(30) Foreign Application Priority Data
Sep. 6, 2023 (JP) 2023-144282

(51) Int. Cl. B25J 9/16; B23K 20/12

(52) U.S. Cl. CPC B25J 9/1664; B23K 20/123; B23K 20/1245

(57) ABSTRACT

A robot welding system that performs friction stir welding of a workpiece includes: a multijoint robot; a pivot member provided at a leading end of an arm of the multijoint robot; and a control apparatus that controls an operation of the multijoint robot and an operation of the pivot member. The control apparatus includes: an estimator configuring to use the arm of the multijoint robot to estimate a flexure direction of the multijoint robot in a case the pivot member is pushed against the workpiece; and a setter configuring to set, based on the flexure direction, a rotational direction of the pivot member so that a friction force generated by the pivot member being in contact with the workpiece is generated in an opposite direction of the flexure direction.

### CROSS REFERENCE TO RELATED APPLICATION

This application is based upon and claims the benefit of priority from Japanese Patent Application No. 2023-144282 filed on Sep. 6, 2023, the contents all of which are incorporated herein by reference.

### FIELD

The present invention relates to a robot welding system that performs friction stir welding of a workpiece.

### BACKGROUND

There is a case where friction stir welding (friction stir bonding) is used in welding of metal. The friction stir bonding is disclosed in, for example, Japanese Unexamined Patent Application Publication No. 2001-340975. Additionally, since the friction stir welding is, for example, preferable for welding of an aluminum component in an electric automotive field, the extended use of the friction stir welding has been expected.

### SUMMARY

A robot welding system according to the present invention is a robot welding system that performs friction stir welding of a workpiece and that includes: a multijoint robot; a pivot member provided at a leading end of an arm of the multijoint robot; and a control apparatus that controls an operation of the multijoint robot and an operation of the pivot member. The control apparatus includes: an estimator configuring to use the arm of the multijoint robot to estimate a flexure direction of the multijoint robot in a case the pivot member is pushed against the workpiece; and a setter configuring to set, based on the flexure direction, a rotational direction of the pivot member so that a friction force generated by the pivot member being in contact with the workpiece is generated in an opposite direction of the flexure direction.

Additionally, in the robot welding system, the estimator is configuring to estimate the flexure direction based on an orientation of the multijoint robot that performs welding of the workpiece with the pivot member.

Furthermore, in the robot welding system, the estimator is configuring to estimate the flexure direction based on an angle of each joint of the multijoint robot.

The robot welding system according to the present invention is capable of increasing welding quality.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a view schematically illustrating an example of an overall configuration of a robot welding system according to an embodiment of the present invention.

FIG. 2 is a block diagram illustrating an example of various functions of a control apparatus included in the robot welding system illustrated in FIG. 1.

FIG. 3 is a view illustrating an example of friction stir welding in a reference example.

FIG. 4 is a view illustrating an example of friction stir welding in the robot welding system illustrated in FIG. 1.

FIG. 5 is a flowchart describing an example of the flow of friction stir welding processing in the robot welding system illustrated in FIG. 1.

### DETAILED DESCRIPTION

An embodiment of the present invention will be described below with reference to the accompanying drawings. Note that in each drawing, an identical constituent element is denoted by an identical reference number as much as possible for facilitating understanding, and an overlapping description is omitted as appropriate.

### Embodiment

### <<Overall Configuration>>

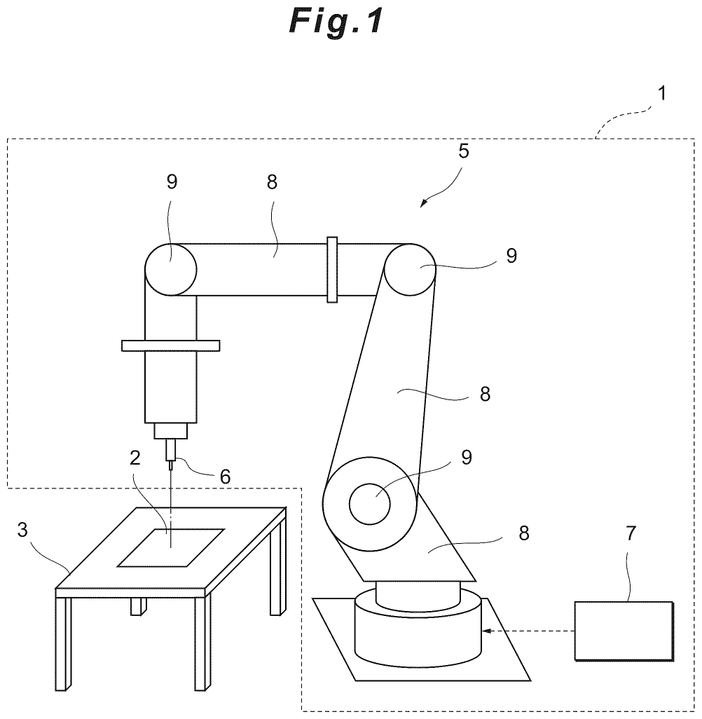

FIG. 1 is a view schematically illustrating an example of an overall configuration of a robot welding system 1 according to an embodiment of the present invention (hereinafter referred to as “the present embodiment”). The robot welding system 1 uses a robot to perform welding of a workpiece 2 as a welding target. Especially, the robot welding system 1 performs welding of the workpiece 2 by friction stir welding (FSW). The workpiece 2 is a member as the welding target, and is, for example, a member made of aluminum metal. The workpiece 2 is, for example, disposed on a rack 3.

The friction stir welding mentioned herein is a type of a solid-phase bonding method, and is advantageous in being less susceptible to restrictions of a metal material, being less susceptible to thermal distortion, and the like. In the friction stir welding, a spindle 6, which will be described later, is pushed into the workpiece 2 in a state where the spindle 6 is rotated in a set direction. With this operation, the workpiece 2 is softened by frictional heat generated between the spindle 6 and the workpiece 2, and mixed by stirring. The spindle 6 is then moved with respect to the workpiece 2, whereby a portion that has been softened and mixed by stirring loses frictional heat, and is cooled and solidified. A portion over which the spindle 6 is moved is softened and mixed by stirring. The above-mentioned action is repeated with the movement of the spindle 6, whereby it is possible to perform welding of the portion over which the spindle 6 is moved. With this configuration, for example, a butting portion of the workpiece 2 is bonded and integrated.

As illustrated in FIG. 1, the robot welding system 1 includes, as main constituent elements, a robot 5, the spindle 6, and a control apparatus 7.

The robot 5 is a multijoint robot, and includes a plurality of arms 8, and a plurality of joints 9. Each joint 9 is provided with a driving motor, which is not illustrated. The robot 5 is movable by control of the driving motor provided in each joint 9 of the robot 5. Note that a configuration of the robot 5 illustrated in FIG. 1 is merely an example.

The spindle 6 is a pivot member provided at the leading end of the arm of the robot 5. The spindle 6 is also referred to as a bonding tool. Specifically, the spindle 6 is detachably mounted on the robot 5 at the leading end of the arm of the robot 5.

An appropriate tool shape of the spindle 6 is selected according to a material of the workpiece 2. For example, a material of the spindle 6 is a nickel (Ni)-based alloy, a cobalt alloy, or tungsten carbide. Additionally, a probe (protrusion) is provided at the leading end of the spindle 6.

The spindle 6 is connected with a forward/backward rotary motor (pivot motor), which is not illustrated, and is configuring to be rotatable forward and backward. That is, the spindle 6 is configuring to allow control of both forward rotation and backward rotation (clockwise rotation and counterclockwise rotation). A rotational direction is set in the control apparatus 7, which will be described later.

The control apparatus 7 is a robot welding control apparatus, and is an information processing device that controls an operation of the robot 5 and an operation of the spindle 6. That is, the control apparatus 7 controls an operation of each unit of the robot welding system 1 to control welding of the workpiece 2. In the friction stir welding, the spindle 6 is pushed into the workpiece 2 to perform welding. Since the spindle 6 is pushed against the workpiece 2, there is a possibility that flexure occurs in the robot 5. Especially, there is a possibility that flexure occurs in the joint 9 between the arms 8 of the robot 5. In a case where the flexure occurs, a force acts on each joint 9 in an opposite direction of a control direction of each joint 9, which is controlled in a direction in which the spindle 6 is pushed for welding, and the joint 9 is brought into a state of being somewhat moved in the opposite direction of the control direction. That is, in a case where the flexure occurs, each joint 9 is brought into a state different from a control amount. Due to this state, there is a possibility that the position of the spindle 6 provided at the leading end of the arm of the robot 5 is deviated from a target position. Hence, the control apparatus 7 performs operation control to prevent the positional deviation of the spindle 6 due to the flexure.

### <<Functional Configuration>>

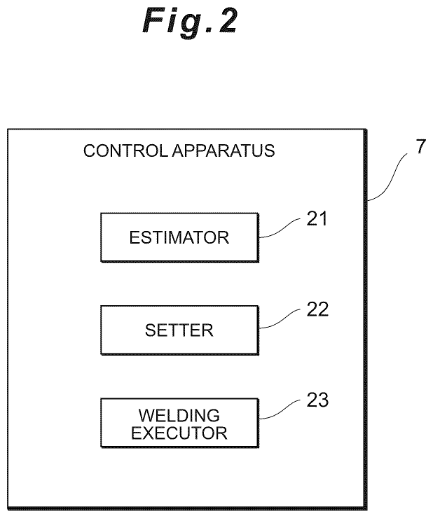

FIG. 2 is a block diagram illustrating an example of various functions in the control apparatus 7 illustrated in FIG. 1. The friction stir welding processing is executed by a function of each block.

As illustrated in FIG. 2, the control apparatus 7 mainly includes an estimator 21, a setter 22, and a welding executor 23.

The estimator 21 estimates the flexure of the robot 5. Specifically, the estimator 21 estimates a flexure direction based on an orientation of the robot 5 that performs welding of the workpiece 2. The flexure direction is estimated as, for example, a flexure direction perpendicular to a rotational axis of the spindle 6.

Since the orientation of the robot 5 relates to an angle of each joint 9 of the robot 5, for example, the estimator 21 estimates the flexure direction based on an angle of each joint 9 of the robot 5. The angle of the joint 9 is estimated based on, for example, a control amount of the driving motor for the joint 9. Note that information is only required to relate to the orientation of the robot 5 and information other than the angle of the joint 9 can be used.

The estimator 21 estimates the flexure direction before the start of welding of the workpiece 2 with the spindle 6. Hence, the estimator 21 estimates the flexure direction based on the orientation of the robot 5 before the start of welding. For example, the estimator 21 preliminarily acquires a target value of the control amount of each joint 9 of the robot 5 for execution of welding, and estimates the flexure direction. Note that the estimator 21 is only required to be capable of estimating the flexure direction before the start of welding but the configuration is not limited thereto. For example, the robot 5 may be moved to a start position of welding and the estimator 21 may check the orientation of the robot 5.

The setter 22 sets a rotational direction of the spindle 6 based on the flexure direction. Specifically, the setter 22 sets the rotational direction of the spindle 6 so that a friction force, which is generated by the spindle 6 being in contact with the workpiece 2, is generated in the opposite direction of the flexure direction. Note that, in the following description, a direction of friction generated by the rotating spindle 6 being in contact with the workpiece 2 is referred to as a “rotational friction direction”.

The spindle 6 comes in contact with the workpiece 2 while rotating in a state where a rotational axis is substantially perpendicular to a surface of the workpiece 2 and moves in a welding direction. Larger friction is generated in the welding direction on a surface of the spindle 6 in contact with the surface of the workpiece 2. That is, on a contact surface between the workpiece 2 and the spindle 6, lager friction is generated on the front side in the welding direction in which the surface of the workpiece 2 has yet to be sufficiently softened and stirred than on the rear side in the welding direction in which the surface of the workpiece 2 has been sufficiently softened and stirred. Hence, the rotational direction of the spindle 6 is set so that the friction force, which is generated on the front side in the welding direction on the contact surface between the workpiece 2 and the spindle 6, is generated in the opposite direction of the flexure direction.

The setter 22 sets the rotational direction of the spindle 6 before the start of welding of the workpiece 2 with the spindle 6. Specifically, before the start of the welding processing by the welding executor 23, which will be described later, the setter 22 sets the rotational direction of the spindle 6.

The welding executor 23 executes welding with the spindle 6. Specifically, the welding executor 23 starts the rotation of the spindle 6 in the rotational direction set by the setter 22. Note that the spindle 6 is rotated so that the number of rotations of the spindle 6 becomes a preliminarily set target number of rotations. The target number of rotations is preliminarily set based on, for example, a material of the workpiece 2 or welding quality. The welding executor 23 then pushes the spindle 6 against a predetermined position, which is a welding start position in the workpiece 2, in a state where the spindle 6 is rotating, and moves the spindle 6 in a predetermined welding direction while pushing the spindle 6 against the predetermined position. The welding direction is set, for example, along a predetermined welding position in the workpiece 2. With this configuration, welding progresses from the welding start position in the welding direction, and the workpiece 2 is bonded. After the welding progresses in the welding direction and is completed until a welding end position, the spindle 6 is separated from the workpiece 2. In this manner, the welding executor 23 executes the welding of the workpiece 2.

### <<Welding Example>

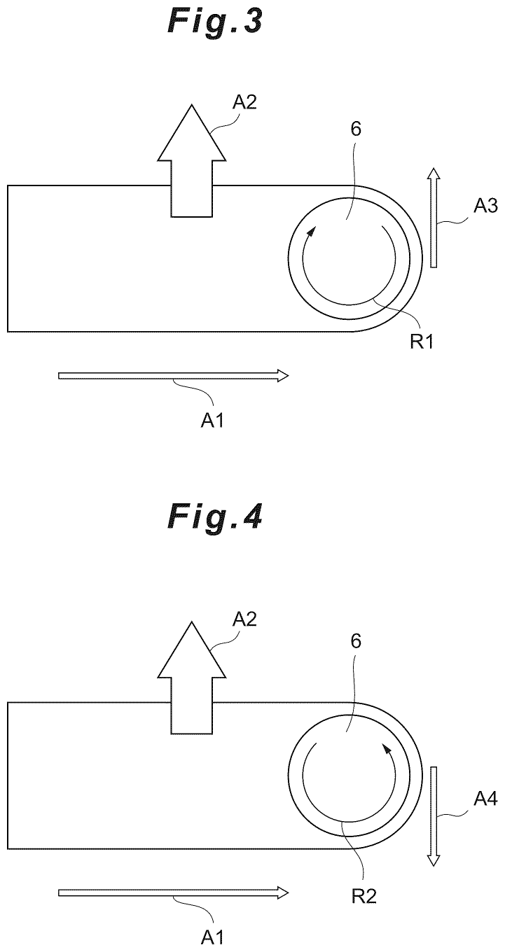

FIGS. 3 and 4 each illustrate an example of friction stir welding. FIG. 3 illustrates an example of friction stir welding in a reference example. FIG. 4 illustrates an example of friction stir welding in the robot welding system 1 illustrated in FIG. 1. In FIGS. 3 and 4, assume that the welding direction and the flexure direction are identical. In FIGS. 3 and 4, the welding direction in the corresponding example is represented by A1, and the flexure direction in the corresponding example is represented by A2. The rotational direction of the spindle 6 in the example in FIG. 3 is represented by R1, and the rotational friction direction in the example in FIG. 3 is represented by A3. The rotational direction of the spindle 6 in the example in FIG. 4 is represented by R2, and the rotational friction direction in the example in FIG. 4 is represented by A4.

FIG. 3 illustrates a case where the flexure direction and the rotational friction direction are identical. When the spindle 6 is rotated in the rotational direction of R1, a friction force is generated in a direction of A3. Since the flexure direction and the rotational friction direction are identical, a large force is generated in this direction. As a result, there is a possibility that the position of the spindle 6 is deviated.

FIG. 4 illustrates a case where the flexure direction and the rotational friction direction are opposite directions. When the spindle 6 is rotated in the rotational direction of R2, a friction force is generated in a direction of A4. Since the flexure direction and the rotational friction direction are opposite directions, forces act in directions so as to cancel each other. For this reason, the deviation of the position of the spindle 6 is suppressed in comparison with the case illustrated in FIG. 3.

While FIG. 4 illustrates the case where the force generated in the flexure direction is larger than the friction force generated in the rotational friction direction, it is possible to suppress the deviation of the position even in a case where the force generated in the flexure direction is smaller than or equal to the friction force generated in the rotational friction direction.

The control apparatus 7 sets the rotational direction of the spindle 6 so that the rotational friction direction is generated in the opposite direction of the flexure direction as illustrated in the example in FIG. 4.

### <<Flow of Processing>>

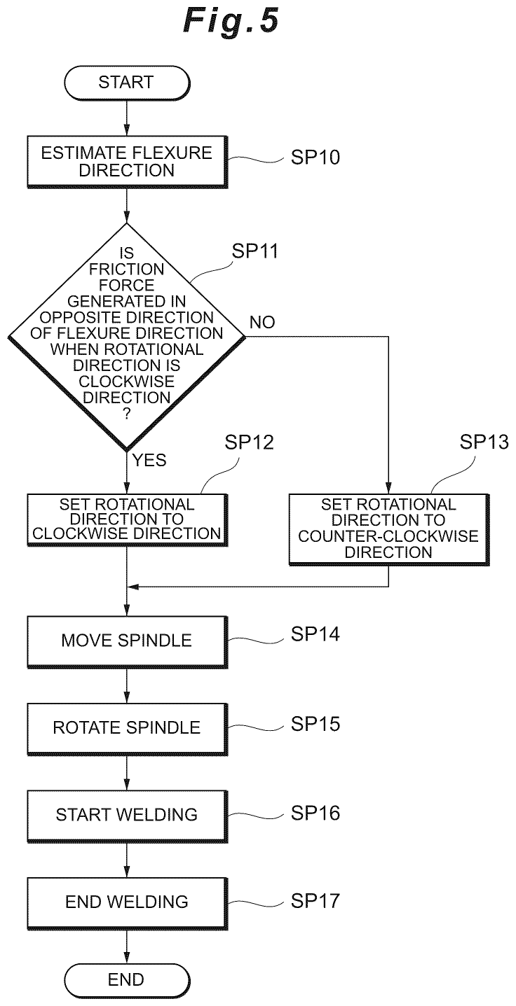

FIG. 5 is a flowchart describing an example of the flow of friction stir welding processing according to the present embodiment. Each processing of the following steps is started, for example, at a timing at which an execution instruction is given by an operator. Note that the following order or contents in each step can be changed as appropriate.

### (Step SP10)

The estimator 21 estimates the flexure direction based on the orientation of the robot 5. For example, the estimator 21 estimates the flexure direction based on the angle of each joint 9 of the robot 5 that executes welding.

### (Step SP11)

The setter 22 determines the rotational direction of the spindle 6 that is rotatable in the clockwise and counter-clockwise directions based on the flexure direction. Specifically, the setter 22 determines whether or not the friction force is generated in the opposite direction of the flexure direction when the rotational direction of the spindle 6 is the clockwise direction. If the friction force is generated in the opposite direction of the flexure direction when the rotational direction is the clockwise direction, the processing proceeds to step SP12. If the friction force is not generated in the opposite direction of the flexure direction when the rotational direction is the clockwise direction, the processing proceeds to step SP13.

### (Step SP12)

The setter 22 sets the rotational direction of the spindle 6 to the clockwise direction.

### (Step SP13)

The setter 22 sets the rotational direction of the spindle 6 to the counterclockwise direction.

The processing in steps SP10 to SP13 described above is preprocessing performed before the execution of welding.

### (Step SP14)

The welding executor 23 causes the robot 5 to move the spindle 6 to the welding start position of the workpiece 2. Note that, in step SP14, the spindle 6 is in a state of being separated from the workpiece 2 and is not in contact with the workpiece 2.

### (Step SP15)

The welding executor 23 rotates the spindle 6 in the set rotational direction.

### (Step SP16)

The welding executor 23 pushes the spindle 6 against the welding start position of the workpiece 2 in a state where the spindle 6 is rotating, and moves the spindle 6 in the welding direction.

### (Step SP17)

After moving the spindle 6 to the welding end position, the welding executor 23 separates the spindle 6 from the workpiece 2.

The friction stir welding is executed by the above-mentioned processing. Especially, since control is performed so that the frictional rotational direction due to the rotation of the spindle 6 becomes the opposite direction of the flexure direction of the robot 5, the deviation of the position of the spindle 6 due to the flexure is suppressed.

### <<Actions and Effect>>

As described above, in the present embodiment, the flexure direction of the robot 5 in a case where the spindle 6 is pushed against the workpiece 2 is estimated, and the rotational direction of the spindle 6 is set so that the friction force generated by the spindle 6 being in contact with the workpiece 2 is generated in the opposite direction of the flexure direction. As a result, it is possible to suppress the deviation of the position of the spindle 6 in the flexure direction with the friction force generated by the rotation of the spindle 6. Hence, it is possible to increase welding quality.

It is possible to estimate the flexure direction based on the orientation of the robot 5 that performs welding of the workpiece 2 with the spindle 6 and appropriately set the rotational direction of the spindle 6.

It is possible to grasp the orientation of the robot 5 based on the angle of each joint 9 of the robot 5 and estimate the flexure direction.

### <<Modification>>

Note that the present invention is not limited to the above-mentioned embodiment. That is, a modification obtained by addition of a design change to the above-mentioned specific examples as appropriate by the person skilled in the art is included in the scope of the present invention as long as the modification has the features of the present invention. Additionally, each element included in the above-mentioned embodiment and the following modification may be combined as long as it is technically viable, and a combination thereof is included in the scope of the present invention as long as the combination has the features of the present invention.

For example, the description has been given of the case where the number of rotations of the spindle 6 is controlled to be the preliminarily set target number of rotations in the present embodiment. But the control is not limited thereto. For example, it is possible to control the number of rotations of the spindle 6. In this case, the number of rotations of the spindle 6 is preferably set so as to cancel out a force generated by the flexure. That is, not only the flexure direction, but also a force in the flexure direction is estimated, whereby the number of rotations is set so that the force is canceled out by a rotational friction force.

For example, in the above-mentioned embodiment, the description has been given of the case where the welding is started after the rotational direction is set, the spindle 6 is moved from the welding start position in the welding direction, and welding is executed until the welding end position. That is, in the above-mentioned embodiment, assume that the flexure direction is substantially identical between the welding start position and the welding end position, and the deviation of the position can be controlled by the friction force in the set rotational direction. However, in a case where the flexure direction and the rotational friction direction in the set rotational direction are not opposite to each other between the welding start position and the welding end position, an intermediate position may be provided between the welding start position and the welding end position, and the rotational direction may be changed at the intermediate position. Note that, in this case, it is preferable that the spindle 6 at the intermediate position be separated from the workpiece 2 once and pushed against the workpiece 2 again after the change of the rotational direction to resume the welding.

For example, the description has been given of the case where the flexure direction and the rotational friction direction are opposite to each other (that is, 180 degrees) in the above-mentioned embodiment, but the present invention is also similarly applicable to a case where the friction force generated by the rotation of the spindle 6 has a component in the opposite direction of the flexure direction. For example, in a case where the friction force generated by the rotation of the spindle 6 acts at 120 degrees with respect to the flexure direction, a force that is half the friction force (=cos 60 degrees) serves as a component in the opposite direction of the flexure direction. Also in this case, it can be said that the friction force, which is generated by the spindle 6 being in contact with the workpiece 2, is generated in the opposite direction of the flexure direction.

For example, the description has been given of the case where the rotational direction is set before the start of the welding in the above-mentioned embodiment, but the rotational direction may be set after the start of the welding if there is no problem such as welding quality of friction stir welding. After the start of the welding is, for example, after the spindle 6 is pushed against the workpiece 2.

What is claimed is:

1. A robot welding system that performs friction stir welding of a workpiece, the robot welding system comprising:
a multijoint robot;
a pivot member provided at a leading end of an arm of the multijoint robot; and
a control apparatus configuring to control an operation of the multijoint robot and an operation of the pivot member,
wherein the control apparatus includes:
an estimator configuring to use the arm of the multijoint robot to estimate a flexure direction of the multijoint robot in a case the pivot member is pushed against the workpiece; and
a setter configuring to set, based on the flexure direction, a rotational direction of the pivot member so that a friction force generated by the pivot member being in contact with the workpiece is generated in an opposite direction of the flexure direction.

2. The robot welding system according to claim 1, wherein the estimator is configuring to estimate the flexure direction based on an orientation of the multijoint robot that performs welding of the workpiece with the pivot member.

3. The robot welding system according to claim 2, wherein the estimator is configuring to estimate the flexure direction based on an angle of each joint of the multijoint robot.
